(19) United States
(12) Patent Application Publication
(10) Pub. No.: US 2009/0322753 A1
(43) Pub. Date: Dec. 31, 2009

(54) METHOD OF AUTOMATICALLY SELECTING DEGREE OF ZOOM WHEN SWITCHING FROM ONE MAP TO ANOTHER

(75) Inventor: Robert E. De Mers, Elk River, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/165,199

(22) Filed: Jun. 30, 2008

(51) Int. Cl. G09G 5/00

(52) U.S. Cl. 345/428

(57) ABSTRACT

A method is described of selecting one of a plurality of zoom levels of a desired map, the map comprising a plurality of data points and each zoom level comprising at least a portion of the data points, the zoom levels ranging from low magnification to high magnification, including selecting (802, 912) a zoom level having a number of data points beyond a threshold. The selecting (802, 912) a zoom level may occur subsequent to selecting (910) a previous map having a plurality of data points wherein each of the zoom levels of the desired map and the previous map include a distinctive number of the data points.

### FIELD

The present invention generally relates to a method of selecting maps on an electronic display and more particularly to a method for selecting the degree of zoom when switching from one map to another.

### BACKGROUND

Modern map displays, particularly those used in aircraft for flight planning and monitoring, are capable of displaying a considerable amount of information such as terrain information and flight planning information. The terrain information may include situational awareness terrain and cautions that identify potential hazards. Flight planning information may include, for example, flight path and altitude information useful to the pilot.

Three dimensional perspective representations of terrain and flight planning information provide better spatial understanding and situation awareness and therefore reduce the navigational workload for a flight crew. A flight path display with a terrain underlay will also significantly enhance the perception of depth and relative location during the flight path visualization therefore reducing flight crew work load and improving the vertical awareness relative to terrain.

These electronic instrumentation displays continue to advance in sophistication, achieving increasingly higher levels of information density and, consequently, presenting a greater amount of visual information to be perceived and understood by the operator, e.g., pilot. It is important that visual displays provide a proper cognitive mapping between what the operator is trying to achieve and the information available to accomplish the task. As a result, displays, especially aircraft displays, tend to be populated with numerous, non-intuitive icons and symbols.

The operator may have many map options available, including aviation maps including, e.g., desired flight path, terrain maps including, e.g., ground obstacles, surface street maps, and the like. In some situations, such as moving map displays, as the operator's distance from the desired geographic target varies, the electronic display may zoom in or zoom out to show more or less detail. However, if the operator desires to switch to another map, for example from a aviation map to a street map, the zoom level may be at an undesired level showing too much or too little detail.

Accordingly, it is desirable to provide a method for automatically selecting the degree of zoom when switching from one map to another. Furthermore, other desirable features and characteristics of the present invention will become apparent from the subsequent detailed description and the appended claims, taken in conjunction with the accompanying drawings and this background.

### BRIEF SUMMARY OF THE INVENTION

A method is described of selecting one of a plurality of zoom levels of a desired map, the map comprising a plurality of data points and each zoom level comprising at least a portion of the data points, the zoom levels ranging from low magnification to high magnification, including selecting a zoom level having a number of data points beyond a threshold. The selecting of a zoom level of a desired map may occur when initially accessing a map or subsequent to selecting a previous map wherein each of the zoom levels of the desired map and the previous map include a distinctive number of the data points.

### BRIEF DESCRIPTION OF THE DRAWINGS

Embodiments of the present invention will hereinafter be described in conjunction with the following drawing figures, wherein like numerals denote like elements, and

FIG. 1 is a functional block diagram of a flight display system in accordance with an exemplary embodiment;

FIG. 2 is an exemplary image of a terrain map that may be rendered on the flight display system of FIG. 1;

FIG. 3 is an exemplary image of a topographical map that may be rendered on the flight display system of FIG. 1;

FIG. 4 is an exemplary image of a first zoom level of an aviation map that may be rendered on the flight display system of FIG. 1;

FIG. 5 is an exemplary image of a first zoom level of a road map that may be rendered on the flight display system of FIG. 1;

FIG. 6 is an exemplary image of a second zoom level of a road map that may be rendered on the flight display system of FIG. 1;

FIG. 7 is an exemplary image of a third zoom level of a road map that may be rendered on the flight display system of FIG. 1;

FIG. 8 is an exemplary image of a second zoom level of an aviation map that may be rendered on the flight display system of FIG. 1.

FIG. 9 is a first flow chart of the steps of the exemplary embodiment; and

FIG. 10 is a second flow chart of the steps of the exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

The mapping methods described herein may be applied to a variety of applications, such as automobile, marine, and aviation; however, an aviation environment is described herein as the exemplary embodiment and may include navigation from point to point or approach and landing at an airport. Various types of maps may be used, for example, road maps, terrain maps, aviation maps, and topographical maps.

Some applications may require more than one monitor, for example, a head down display screen, to accomplish the mission. These monitors may include a two dimensional moving map display and a three dimensional perspective display. A moving map display may include a top-down view of the aircraft, the flight plan, and the surrounding environment. Various symbols are utilized to denote navigational cues (e.g., waypoint symbols, line segments interconnecting the waypoint symbols, range rings) and nearby environmental features (e.g., terrain, weather conditions, political boundaries, etc).

The moving map display and the perspective display each provide a pilot (or other observer) with important navigational information. For example, the moving map display permits a pilot to easily determine the aircraft's location with reference to geographical landmarks, including significant geographical features (e.g., ridges, mountain ranges, valleys, etc.) and man-made structures (e.g., airports). Consequently, a pilot may refer to the moving map display when guiding an aircraft to a particular destination. The perspective display, by comparison, provides information regarding the aircraft's orientation (e.g., the aircraft's attitude, altitude, pitch, roll, etc.) and aspects of nearby geographical features in an intuitive manner. Thus, a pilot may refer to the perspective display when navigating around a geographical feature, such as a mountain.

Alternate embodiments of the present invention to those described below may utilize whatever navigation system signals are available, for example a ground based navigational system, a GPS navigation aid, a flight management system, and an inertial navigation system, to dynamically calibrate and determine a precise course.

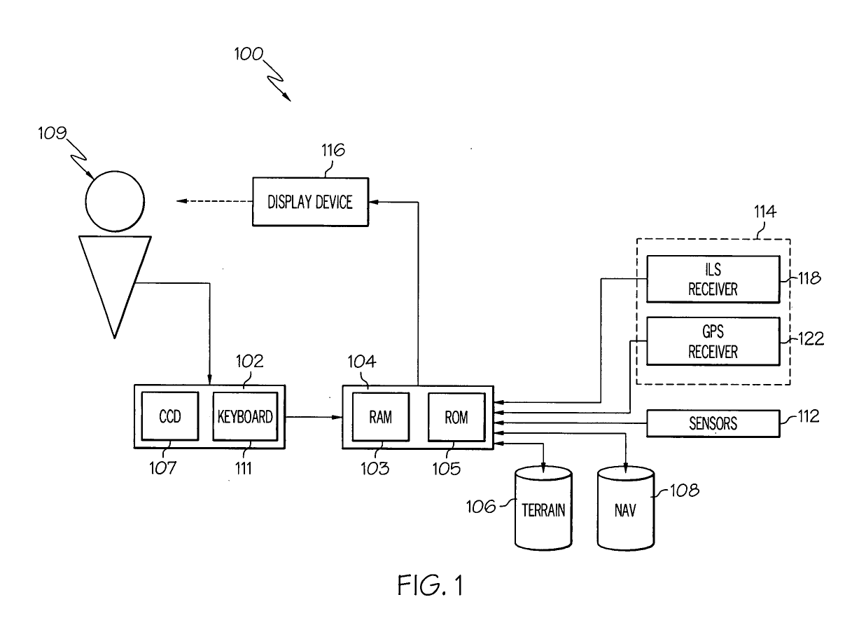

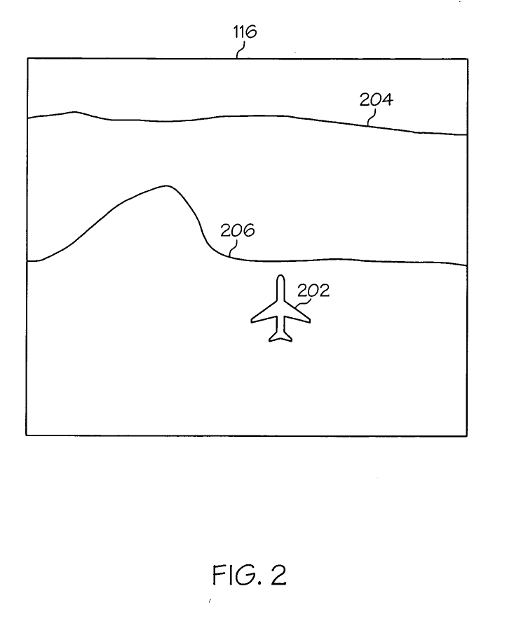

Referring to FIG. 1, an exemplary flight deck display system is depicted and will be described. The system 100 includes a user interface 102, a processor 104, one or more terrain databases 106, one or more navigation databases 108, various sensors 112, various external data sources 114, and a display device 116. The user interface 102 is in operable communication with the processor 104 and is configured to receive input from a user 109 (e.g., a pilot) and, in response to the user input, supply command signals to the processor 104. The user interface 102 may be any one, or combination, of various known user interface devices including, but not limited to, a cursor control device (CCD) 107, such as a mouse, a trackball, or joystick, and/or a keyboard, one or more buttons, switches, or knobs. In the depicted embodiment, the user interface 102 includes a CCD 107 and a keyboard 111. The user 109 uses the CCD 107 to, among other things, move a cursor symbol on the display screen (see FIG. 2), and may use the keyboard 111 to, among other things, input textual data.

The processor 104 may be any one of numerous known general-purpose microprocessors or an application specific processor that operates in response to program instructions. In the depicted embodiment, the processor 104 includes on-board RAM (random access memory) 103, and on-board ROM (read only memory) 105. The program instructions that control the processor 104 may be stored in either or both the RAM 103 and the ROM 105. For example, the operating system software may be stored in the ROM 105, whereas various operating mode software routines and various operational parameters may be stored in the RAM 103. It will be appreciated that this is merely exemplary of one scheme for storing operating system software and software routines, and that various other storage schemes may be implemented. It will also be appreciated that the processor 104 may be implemented using various other circuits, not just a programmable processor. For example, digital logic circuits and analog signal processing circuits could also be used.

No matter how the processor 104 is specifically implemented, it is in operable communication with the terrain databases 106, the navigation databases 108, and the display device 116, and is coupled to receive various types of inertial data from the various sensors 112, and various other avionics-related data from the external data sources 114. The processor 104 is configured, in response to the inertial data and the avionics-related data, to selectively retrieve terrain data from one or more of the terrain databases 106 and navigation data from one or more of the navigation databases 108 (including surface features such as roads), and to supply appropriate display commands to the display device 116. The display device 116, in response to the display commands, selectively renders various types of textual, graphic, and/or iconic information. The preferred manner in which the textual, graphic, and/or iconic information are rendered by the display device 116 will be described in more detail further below. Before doing so, however, a brief description of the databases 106, 108, the sensors 112, and the external data sources 114, at least in the depicted embodiment, will be provided.

The terrain databases 106 include various types of data representative of the terrain over which the aircraft is flying, and the navigation databases 108 include various types of navigation-related data. These navigation-related data include various flight plan related data such as, for example, waypoints, distances between waypoints, headings between waypoints, data related to different airports, navigational aids, obstructions, special use airspace, political boundaries, communication frequencies, and aircraft approach information. It will be appreciated that, although the terrain databases 106 and the navigation databases 108 are, for clarity and convenience, shown as being stored separate from the processor 104, all or portions of either or both of these databases 106, 108 could be loaded into the RAM 103, or integrally formed as part of the processor 104, and/or RAM 103, and/or ROM 105. The terrain databases 106 and navigation databases 108 could also be part of a device or system that is physically separate from the system 100.

The sensors 112 may be implemented using various types of inertial sensors, systems, and or subsystems, now known or developed in the future, for supplying various types of inertial data. The inertial data may also vary, but preferably include data representative of the state of the aircraft such as, for example, aircraft speed, heading, altitude, and attitude. The number and type of external data sources 114 may also vary. For example, the external systems (or subsystems) may include, for example, a terrain avoidance and warning system (TAWS), a traffic and collision avoidance system (TCAS), a runway awareness and advisory system (RAAS), a flight director, and a navigation computer, just to name a few. However, for ease of description and illustration, only an instrument landing system (ILS) receiver 118 and a global position system (GPS) receiver 122 are depicted in FIG. 1.

The display device 116, as noted above, in response to display commands supplied from the processor 104, selectively renders various textual, graphic, and/or iconic information, and thereby supply visual feedback to the user 109. It will be appreciated that the display device 116 may be implemented using any one of numerous known display devices suitable for rendering textual, graphic, and/or iconic information in a format viewable by the user 109. Non-limiting examples of such display devices include various cathode ray tube (CRT) displays, and various flat panel displays such as various types of LCD (liquid crystal display) and TFT (thin film transistor) displays. The display device 116 may additionally be implemented as a panel mounted display, a HUD (head-up display) projection, or any one of numerous known technologies. It is additionally noted that the display device 116 may be configured as any one of numerous types of aircraft flight deck displays. For example, it may be configured as a multi-function display, a horizontal situation indicator, or a vertical situation indicator, just to name a few. In the depicted embodiment, however, the display device 116 is configured as a navigation display.

The display device 116 is used to display various images and data, in both a graphical and a textual format, and to supply visual feedback to the user 109 in response to the user input commands supplied by the user 109 to the user interface 102. It will be appreciated that the display device 116 may be implemented using any one of numerous known display devices suitable for rendering image and/or text data in a format viewable by the user 109. Non-limiting examples of such display devices include various cathode ray tube (CRT) displays, and various flat panel displays such as, various types of LCD (liquid crystal display) and TFT (thin film transistor) displays. The display device 116 may additionally be implemented as a panel mounted display, a HUD (head-up display) projection, or any one of numerous known technologies.

FIGS. 2-7 include examples of the types of maps that may be displayed on the display device 116, wherein the pilot switches from one map to another depending on the flight situation. FIGS. 2-4 illustrate examples of a terrain map, a topographical map, and an aviation map, respectively. The terrain map of FIG. 2 includes an aircraft icon 202, the horizon 204, and a hill 206. Each of these items is known as a data point. Although only one zoom level is shown, a larger view of the terrain map (a lower zoom level) could include other data points such as a lake, a river, a mountain, and the like.

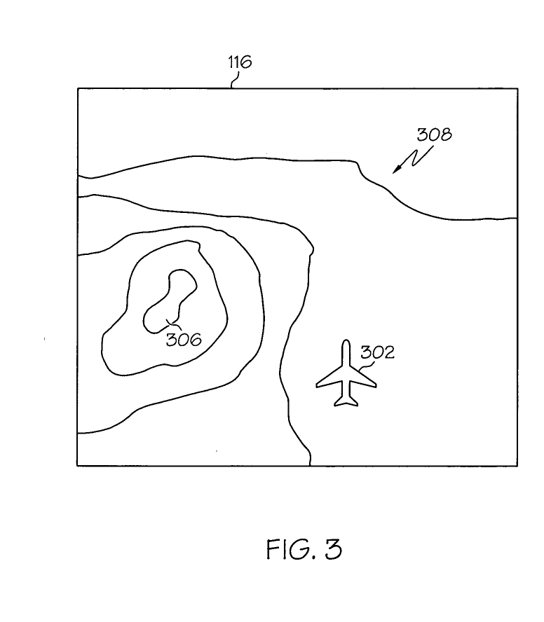

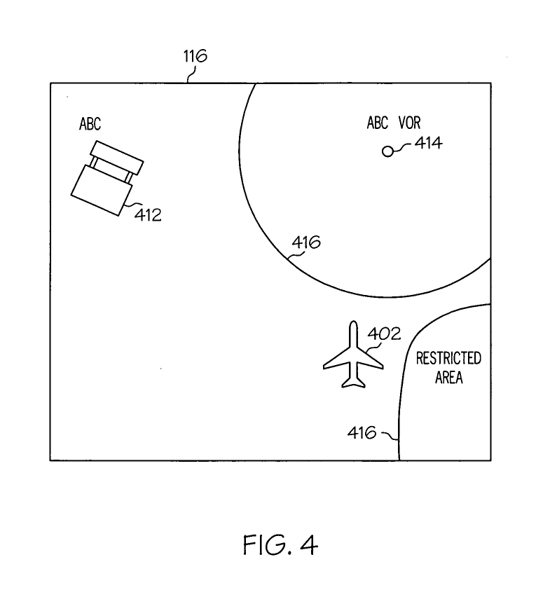

The topographical map of FIG. 3 displays data points including an aircraft icon 302 and various altitude gradients 308 of the hill 306. The aviation map of FIG. 4 displays data points including an aircraft icon 402, an airport 412, a VOR navigational aid 414, a circle 416 indicating a seven mile radius from the VOR 414, and a restricted area 416.

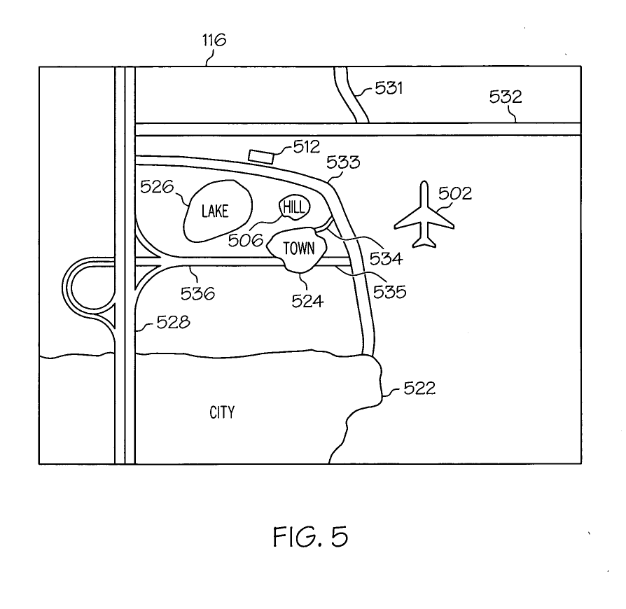

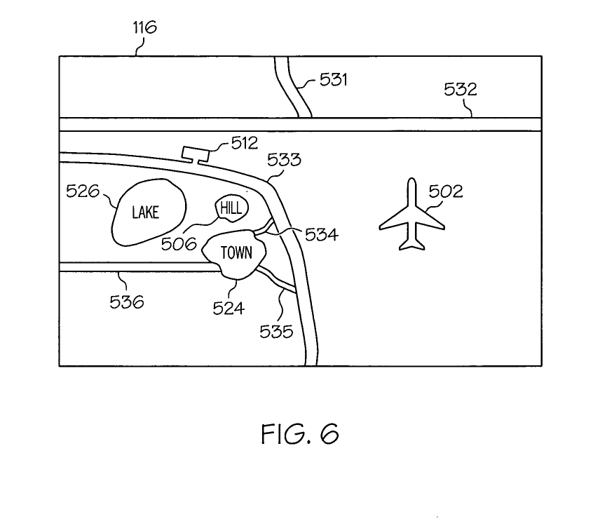

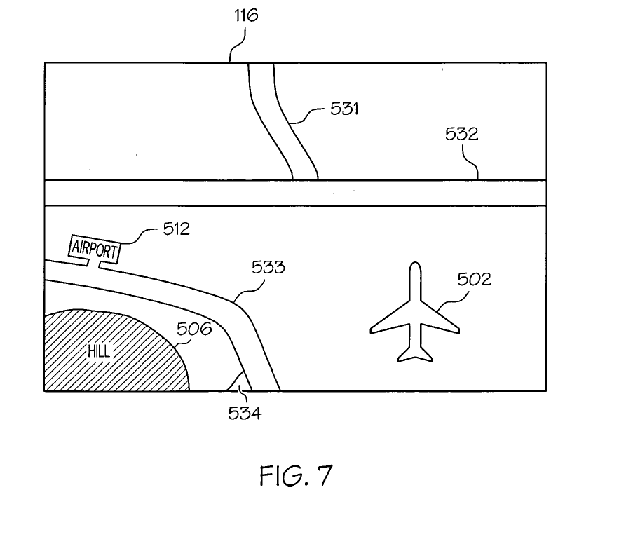

FIGS. 5-7 are road maps of three different zoom levels, where FIG. 5 is the lowest magnification and includes twelve data points including an aircraft icon 502, a hill 506, an airport 512, a city 522, a town 524, a lake 526, an interstate highway 528, and roads 531, 532, 533, 534, 535, 536. FIG. 6 is a magnified view (zoomed in) of the map of FIG. 5 and includes only 10 of the data points of FIG. 5, including the aircraft icon 502, hill 506, airport 512, town 524, lake 526, and roads 531, 532, 533, 534, 535, 536. FIG. 7 is a further magnified view of the map of FIG. 5 and includes only 6 of the data points of FIG. 5, including the aircraft icon 502, hill 506, airport 512, and roads 531, 532, 533, 534.

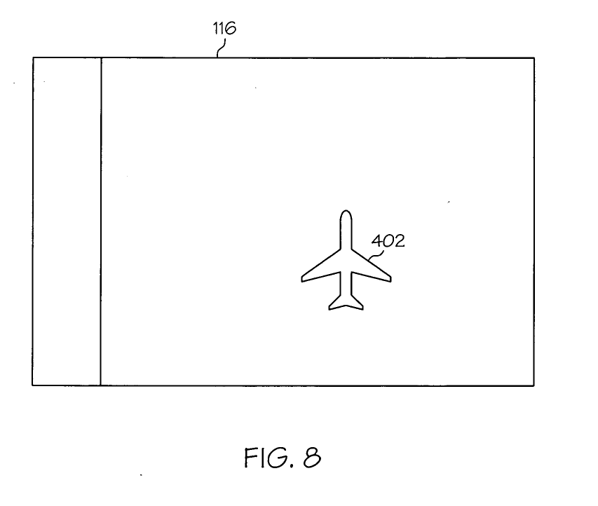

When selecting the aviation map when another type of map is being displayed, e.g., a road map, and if the zoom level of the displayed map is low (high magnification: few data points are illustrated), it is desirable that the zoom level of the selected map have a sufficient zoom level for the pilots to identify the location. A roadmap is more likely to show details when zoomed way in than the other types of map. One possible scenario is for the pilots to zoom in on the road map in order to locate a particular address. The pilots may want to differentiate objects that may be only tens of feet apart. This would be typical of a police helicopter. Upon finding the location of the house, the pilots may then switch back to the aviation map so that they can locate local radio beacons, landing sites, tall obstacles, etc. However, the current zoom level, while useful for a house location, could show no objects at all in the aviation mode (see FIG. 8). Aviation obstacles and beacons can be miles apart, and usually are. The pilot must now manually zoom out until the map displays enough objects for them to get their bearings, for example, FIG. 5, 6, or 7. The method described herein automates that manual process by automatically detecting that no objects will be present and zooming out to a useful level. Therefore, in accordance with the exemplary embodiment, a threshold of a number of data points is identified for each of the types of maps (terrain, topographical, aviation, road). When selecting that particular type of map, the zoom level is displayed that exceeds but is closest to that threshold (within the pilot's cognitive ability).

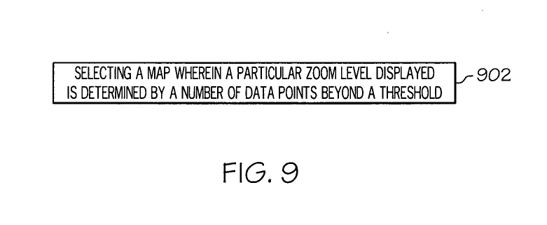

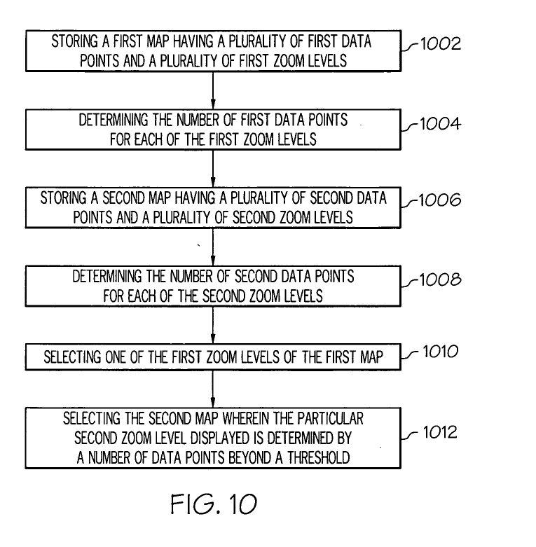

In accordance with the exemplary embodiment and referring to the flow chart of FIG. 9, a map is selected 902 wherein a particular zoom level displayed is determined by a number of data points beyond a threshold. This applies to when first turning on the display, or when selecting a map when another map is being displayed as shown in FIG. 10, wherein a first map having a plurality of first data points and a plurality of first zoom levels is stored 1002. The number of first data points for each of the first zoom levels is determined 1004. A second map having a plurality of second data points and a plurality of second zoom levels is stored 1006 and the number of second data points for each of the second zoom levels is determined 1008. Having previously selected one of the first zoom levels of the first map, the second map is selected 1010 wherein the particular second zoom level displayed is determined by a number of data points beyond a threshold.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method of selecting one of a plurality of zoom levels of a map, the map comprising a plurality of data points and each zoom level comprising at least a portion of the data points, the zoom levels ranging from low magnification to high magnification, comprising:
selecting a zoom level having a number of data points beyond a threshold.

2. The method of claim 1 wherein the selecting step comprises selecting the zoom level having the number of data points closest to the threshold and the lowest magnification.

3. The method of claim 1 wherein the selecting step comprises selecting the zoom level having the number of data points closest to the threshold and the highest magnification.

4. The method of claim 1 wherein the selecting step comprises selecting a zoom level having a data points pre-determined to be within a user's cognitive ability.

5. The method of claim 1 wherein selecting a zoom level comprises illustrating a selected one of the group consisting of a road map, a terrain map, an aviation map, and a topographical map.

6. The method of claim 1 wherein selecting a zoom level comprises illustrating a terrain map including a horizon.

7. The method of claim 1 wherein selecting a zoom level comprises illustrating a topographical map including altitude gradients.

8. The method of claim 1 wherein selecting a zoom level comprises illustrating an aviation map including a navigational aid.

9. The method of claim 1 wherein selecting a zoom level comprises illustrating a road map including at least one of the items selected from the group consisting of a hill, a city, a lake, a railway, a river, and a road.

10. A method of switching to one of a plurality of second zoom levels of a second map when viewing one of a plurality of first zoom levels of a first map, wherein each of the first and second maps have a plurality of data points and each of the first and second zoom levels include a distinctive number of the data points, comprising:
selecting the one of a plurality of second zoom levels based on the number of data points beyond a threshold.

11. The method of claim 10 wherein the selecting step comprises selecting a second zoom level different from the first map zoom level being viewed.

12. The method of claim 10 wherein the selecting step comprises selecting a second zoom level having a number of data points different from the number of data points being viewed on the first map.

13. The method of claim 10 further comprising:
storing the first map having the plurality of first data points and the plurality of first zoom levels;
determining the number of first data points for each of the first zoom levels;
storing the second map having the plurality of second data points and the plurality of second zoom levels;
determining the number of second data points for each of the second zoom levels, wherein the selecting step is performed subsequent to having selected one of the first zoom levels of the first map.

14. A map system comprising:
a memory for storing a first map having a plurality of first data points and a second map having a plurality of second data points;
a processor adapted to select one of a plurality of zoom levels of the first and second maps, wherein each of the zoom levels include a distinctive number of the data points; and
a display device coupled to processor for displaying one of the zoom levels of the second map based on the number of data points beyond a threshold.
